(19) United States
(12) Patent Application Publication
(10) Pub. No.: US 2008/0144058 A1
(43) Pub. Date: Jun. 19, 2008

(54) IMAGE FORMING APPARATUS AND CONTROL METHOD THEREOF

(75) Inventor: Sang-hyun PARK, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/945,409

(22) Filed: Nov. 27, 2007

(30) Foreign Application Priority Data
Dec. 18, 2006 (KR) 2006-129704

(51) Int. Cl. G06F 15/00

(52) U.S. Cl. 358/1.9

(57) ABSTRACT

An image forming apparatus includes: a data receiving part that receives printing information and image data from a storage medium that stores the printing information and the image data; a printing part that prints the image data; and a controller that controls the printing part to print an information image based on the printing information before printing the image data. With this configuration, a user's convenience is improved and a consumption of a printing medium is minimized, while printing an image data stored in a storage medium.

### CROSS-REFERENCE TO RELATED APPLICATION

This application claims the benefit of Korean Application No. 2006-129704, filed Dec. 18, 2006, in the Korean Intellectual Property Office, the disclosure of which is incorporated herein by reference.

### BACKGROUND OF THE INVENTION

1. Field of the Invention

Aspects of the present invention relate to an image forming apparatus and a control method thereof, and more particularly, to an image forming apparatus that prints printing data stored in a storage medium and a control method thereof.

2. Description of the Related Art

An image forming apparatus prints printing data on a printing medium, thereby producing an image. The image forming apparatus may be a printer or a multifunctional device, etc., that performs a printing process on a printing medium such as paper to reproduce the printing data, which can be a text, a picture, a photograph or the like. The image forming apparatus receives a printing data from a host device, e.g., a computer system, or a printing data generated in a digital camera and stored in a memory card (hereinafter, referred to as a storage medium).

The printing data is provided in a digital print order format (DPOF) which allows a user to determine which of a plurality of printing data, i.e., a plurality of images, stored in the storage medium is to be printed and provides printing information. The printing information includes the number of copies to be printed, the size of a paper, a title of an image, a rotational direction for rotating an image, etc. The DPOF is stored as a text file in a predetermined directory of the storage medium and may be accessed through a menu mode of the digital camera or the like.

If the storage medium to store the DPOF printing data is installed in an image forming apparatus that supports the DPOF, the image forming apparatus checks out whether there is DPOF printing data in the storage medium. Then, the image forming apparatus informs the user that the DPOF printing data is to be printed, and prints the DPOF printing data when the user authorizes a DPOF printing.

When performing the DPOF printing, however, a conventional image forming apparatus acts only on the user's decision of whether to print the DPOF printing data and does not provide the user with the printing information that is included with the DPOF printing data. Thus, if the DPOF printing data in the storage medium was not stored by the user or if the DPOF printing data was stored a long time ago, the user may not know or remember the contents of the DPOF printing data and how the DPOF printing data was set to be stored. In this case, the user must print the DPOF printing data to find out the contents of the DPOF printing data. If the user is looking for a particular image, the user may have to repeat printing until finding a desired image. Accordingly, such unnecessary printing causes the user's inconvenience and the excess consumption of printing medium, toner, and the like.

### SUMMARY OF THE INVENTION

Accordingly, it is an aspect of the present invention to provide an image forming apparatus and a control method thereof that improves a user's convenience and minimizes a consumption of a printing medium when printing data stored in a storage medium.

Additional aspects of the present invention will be set forth in part in the description which follows and, in part, will be obvious from the description, or may be learned by practice of the present invention.

The foregoing and/or other aspects of the present invention can be achieved by providing an image forming apparatus including: a data receiving part that receives printing information and image data from a storage medium storing the printing information and the image data; a printing part that prints the image data; and a controller that controls the printing part to print an information image based on the printing information before printing the image data.

According to an aspect of the present invention, the controller may analyze a digital print order format (DPOF) script to obtain the printing information.

According to an aspect of the present invention, the information image may include at least one of items about an expected printing image, a file name, a file format, a printing format, the number of copies to be printed, the size of a printing medium and a rotational direction for rotating a printing image.

According to an aspect of the present invention, the expected image of the information image may be reduced in size from the printing image.

According to an aspect of the present invention, the controller may control the printing part to print a plurality of information images on one page of the printing medium.

According to an aspect of the present invention, the image forming apparatus may further include a display part that displays an information image according to control by the controller.

Another aspect of the present invention provides a control method of an image forming apparatus including: obtaining printing information from a storage medium that stores the printing information and image data; and printing an information image based on the obtained printing information before printing the image data.

Another aspect of the present invention provides an image forming apparatus including: a display part that displays an image; a data receiving part that receives printing information and image data from a storage medium storing the printing information and the image data; a printing part that prints the image data; and a controller that controls the display part to display an information image based on the printing information before printing the image data.

Another aspect of the present invention provides a control method of an image forming apparatus including: obtaining printing information from a storage medium storing the printing information and image data; and displaying an information image based on the obtained printing information before printing the image data.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram to illustrate a configuration of an image forming apparatus according to an embodiment of the present invention;

FIG. 2 illustrates an example of an information image according to the embodiment of FIG. 1;

FIG. 3 illustrates the example of the information image of FIG. 2 in detail;

FIG. 4 is a flow chart to illustrate an operation of the image forming apparatus according to the embodiment of FIG. 1; and

FIG. 5 is a flow chart to illustrate an operation of an image forming apparatus according to another embodiment of the present invention

### DETAILED DESCRIPTION OF EXEMPLARY EMBODIMENTS OF THE INVENTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

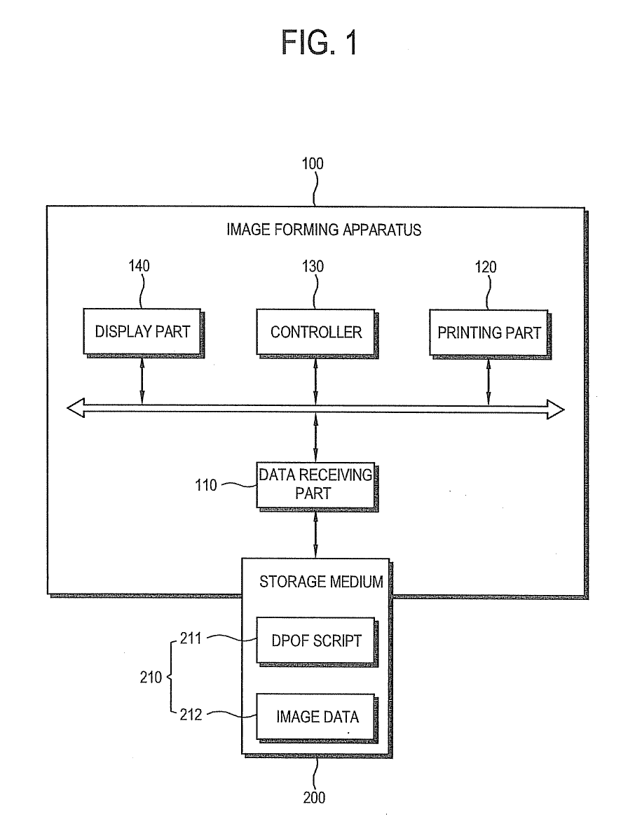

FIG. 1 is a block diagram to illustrate a configuration of an image forming apparatus 100 according to an embodiment of the present invention. The image forming apparatus 100 may be a printer or a multifunctional device, etc., that includes printing capability. The image forming apparatus 100 includes a data receiving part 110, a printing part 120 and a controller 130.

The data receiving part 110 receives a printing data 210 from a storage medium 200. Non-limiting examples of the storage medium 200 include memory cards or the like. The image forming apparatus 100 may further include an installation part (not shown) to install the storage medium 200. The data receiving part 110 reads the printing data 210 stored in the storage medium 200 in a digital print order format (DPOF) and transmits it to the controller 130 according to control by the controller 130. For example, the controller may direct the data receiving part 110 to read the printing data 210 when the storage medium 200 is installed in the installation part of the image forming apparatus 100. The printing data 210 includes a DPOF script 211 which has the printing information, and an image data 212 corresponding to an image.

The printing part 120 prints the printing data 210 received from the data receiving part 110 on a printing medium such as a paper according to control by the controller 130. The printing part 120 may print the printing data 210 by an ink-jet method, a laser method, etc.

The controller 130 controls the printing part 120 to print the printing data 210 received from the data receiving part 110. The controller 130 analyzes the DPOF script 211 of the printing data 210 so that the printing part 120 performs printing. In detail, if the storage medium 200 is installed in the installation part of the image forming apparatus 100, the controller 130 checks whether there is the DPOF script 211 in an assigned directory of the storage medium 200. The DPOF script 211 is a format of a text file. The DPOF script 211 may be identified by a file name such as, for example, AUTOPRINT.MRK. An example of the DPOF script 211 is illustrated as follows.

[DPOF script]

### [HDR]

### GEN REV=01.00

### GEN CRT=“Samsung Print”−01.00

### GEN DTM=2006:08:10:21:30:00

### [JOB]

### PRT PID=001

### PRT TYP=STD

### PRT QTY=002

### IMG FMT=CIFF1

### <IMG□SRC=“../DC94/CTG_{—}0000/AUT_{—}0001.JPG”>

### [JOB]

### PRT PID=002

### PRT TYP=STD

### PRT QTY=001

### CFG ROT=90

### IMG FMT=CIFF1

### <IMG□SRC=“../DC94/CTG_{—}0000/AUT_{—}0001.JPG”>

### [JOB]

### PRT PID=003

### PRT TYP=IDX

### IMG FMT=EXIF2-J

### IMG SRC=“../IM01EXIF/EXIF00002.JPG”

### IMG SRC=“../IM01EXIF/EXIF00003.JPG”

### IMG SRC=“../IM01EXIF/EXIF00004.JPG”

### IMG SRC=“../IM01EXIF/EXIF00005.JPG”

The controller 130 loads and analyzes the DPOF script 211 consecutively by the process (referred to [JOB] in the [DPOF script]). In the DPOF script, PRT indicates a printing command including parameters such as, PID, an ID for the process; TYP, a printing mode; QTY, the number of copies to be printed; and PSL, the size of a paper. Meanwhile, IMG indicates a command to a printing image including parameters such as, FMT, a file format; and SRC, a location of the file. The controller 130 controls the printing part 120 to print the image data 212 according to the printing information.

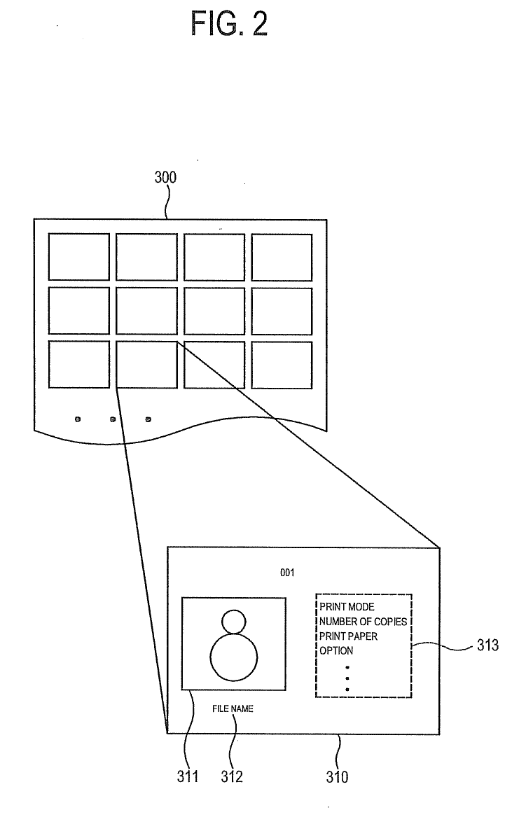

In the present embodiment, the controller 130 may control the printing part 120 to print an information image 310 (see FIG. 2) previewing the printing data 210 to be printed before printing the printing data 210.

FIG. 2 is an example of the information image 310. In FIG. 2, the reference numeral 300 indicates a printing medium, e.g., a piece of paper. The controller 130 controls the printing part 120 to print the information image 310 relating to the printing data 210 based on printing information obtained through an analysis of the DPOF script 211. The printing part 120 generates the data 210 of the information image 310 and prints the information image 310 on the basis of the generated data according to control by the controller 130.

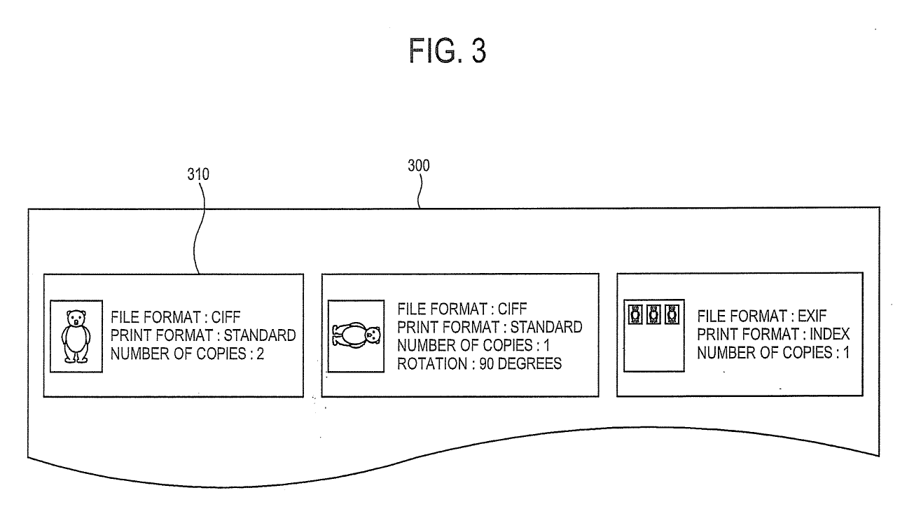

Referring to FIG. 2, the information image 310 includes an expected printing image 311 of the printing data 210, a file name 312, etc. Also, the information image 310 may further include information 313 on a file format, a printing format, the number of copies to be printed, the size of the paper, the rotational direction for rotating the printing image and the like. In the present embodiment, a plurality of information images 310 may be printed on one piece of paper 300. In this case, the expected printing images 311 may be reduced in size considering the size of the paper 300. FIG. 3 shows an example of the information image 310 in detail.

Alternatively, the image forming apparatus 100 may further include a display part 140. The image forming apparatus 100 may further include a user operation panel (not shown) for interface with a user and the display part 140 may be provided on the user operation panel. The controller 130 may control the display part 140 to display an information image about a printing data on the basis of printing information obtained through an analysis of the DPOF script 211. The display part 140 generates an image data of the information image and displays the information image on the basis of the generated image data according to control by the controller 130.

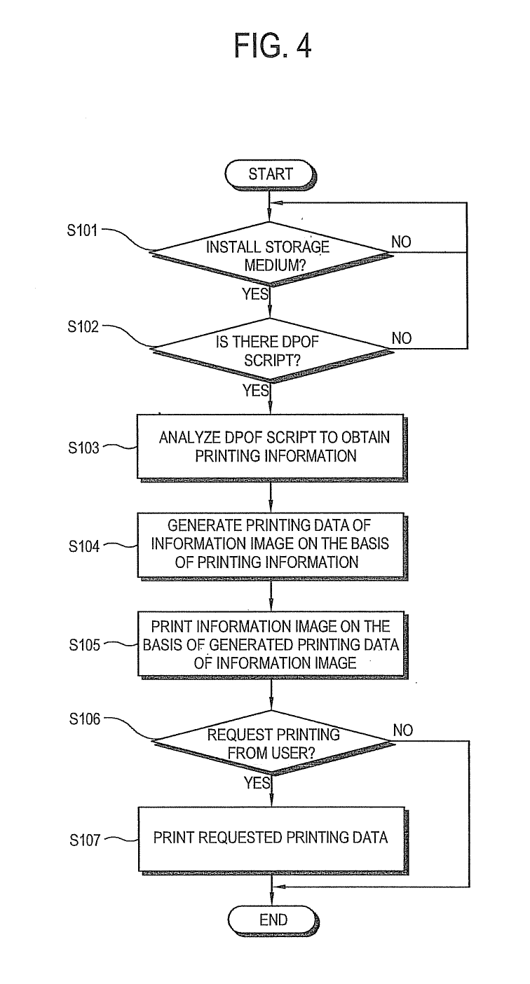

FIG. 4 is a flow chart to illustrate an operation of the image forming apparatus according to an embodiment of the present invention. First, the controller 130 checks whether the storage medium 200 is installed in the installation part (S101). If the storage medium 200 is installed in the installation part, the controller 130 checks whether the storage medium 200 includes DPOF script 211 of printing data 210 (S102). If the storage medium 200 includes DPOF script 211, the controller 130 analyzes the DPOF script 211 to obtain the printing information about the printing data 210 to be printed (S103).

Then, the controller 130 controls the printing part 120 to generate the data of the information image 310 on the basis of the obtained printing information of the printing data 210 (S104). Then, the printing part 120 forms the information image 310 on the printing medium, such as paper or the like, by printing the data of the generated information image 310 (S105).

Subsequently, the controller 130 checks whether it is requested by the user to print the printing data 210 (S106). The image forming apparatus 100 can check through the user operation panel whether the user requests printing the printing data 210. If there is a request for printing from the user, the controller 130 controls the printing part 120 to print the requested printing data 210 (S107).

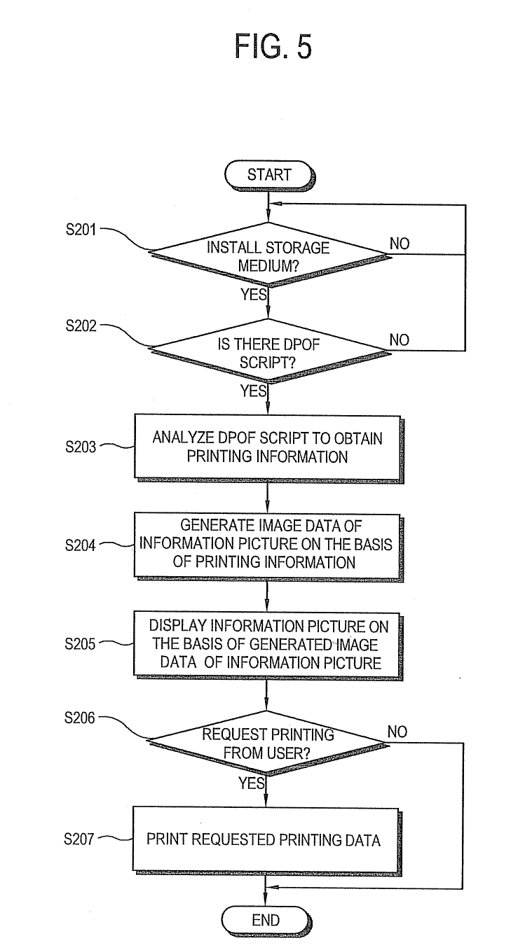

FIG. 5 is a flow chart to illustrate an operation of an image forming apparatus according to another embodiment of the present invention. First, operations S201 through S203 are the same or similar to the operations S101 through S103 described with reference to FIG. 4, and thus descriptions thereof will not be repeated. Next, a controller 130 controls the display part 140 to generate the image data of an information image on the basis of the printing information of the printing data 210 obtained at operation S203 (S204). The printing part 120 displays the information image on the basis of the generated image data of the information image (S205). The following operations S206 and S207 are the same or similar to the operations S106 and S107 described with reference to FIG. 4.

As describe above, the present invention provides an image forming apparatus and a control method thereof which displays an expected image to be printed, a printing setup, etc. prior to printing a printing data stored in a storage medium, thereby improving a user's convenience and minimizing the consumption of a printing medium.

Although a few embodiments of the present invention have been shown and described, it will be appreciated by those skilled in the art that changes may be made in this embodiment without departing from the principles and spirit of the invention, the scope of which is defined in the appended claims and their equivalents.

What is claimed is:

1. An image forming apparatus comprising:
a data receiving part that receives printing information and image data from a storage medium storing the printing information and the image data;
a printing part that prints the image data; and
a controller that controls the printing part to print an information image based on the printing information before the printing part prints the image data.

2. The image forming apparatus according to claim 1, wherein the controller analyzes a digital print order format (DPOF) script to obtain the printing information.

3. The image forming apparatus according to claim 1, wherein the information image comprises at least one of an expected printing image, a file name, a file format, a printing format, the number of copies to be printed, the size of a printing medium and a rotational direction to rotate a printing image.

4. The image forming apparatus according to claim 3, wherein the expected image of the information image is reduced in size from the printing image.

5. The image forming apparatus according to claim 1, wherein the controller controls the printing part to print a plurality of information images on one printing medium.

6. The image forming apparatus according to claim 1, further comprising a display part that displays the information image according to control by the controller.

7. A control method of an image forming apparatus comprising:
obtaining printing information from a storage medium that stores the printing information and image data; and
printing information image based on the obtained printing information before printing the image data.

8. The control method of the image forming apparatus according to claim 7, wherein the obtaining of the printing information comprises analyzing a digital print order format (DPOF) script.

9. The control method of the image forming apparatus according to claim 7, wherein the information image comprises at least one of an expected printing image, a file name, a file format, a printing format, the number of copies to be printed, the size of a printing medium and a rotational direction to rotate a printing image.

10. The control method of the image forming apparatus according to claim 9, wherein the expected image of the information image is reduced in size from the printing image.

11. The control method of the image forming apparatus according to claim 7, wherein the printing comprises printing a plurality of the information images on one printing medium.

12. The control method of the image forming apparatus according to claim 7, further comprising displaying an information image based on the printing information.

13. The control method of the image forming apparatus according to claim 7, wherein the method further comprises printing the image data only after an authorization from a user is received.

14. An image forming apparatus comprising:
a display part that displays an image;
a data receiving part that receives printing information and image data from a storage medium storing the printing information and the image data;
a printing part that prints the image data; and
a controller that controls the display part to display an information image on the basis of the printing information before printing the image data.

15. A control method of an image forming apparatus comprising:
obtaining printing information from a storage medium storing the printing information and image data; and
displaying an information image based on the obtained printing information before printing the image data.

16. The control method of the image forming apparatus according to claim 15, wherein the method further comprises printing the image data only after an authorization from a user is received.
